(19) United States
(12) Patent Application Publication
(10) Pub. No.: US 2025/0303662 A1
(43) Pub. Date: Oct. 2, 2025

(54) COMPOSITE PANELS HAVING AN INTEGRATED ATTACHMENT FEATURE AND METHODS FOR MAKING THE SAME

(71) Applicant: General Electric Company, Schenectady, NY (US)

(72) Inventors: Daniel Gene Dunn, Guilderland, NY (US); Jared Hogg Weaver, Clifton Park, NY (US); Scott Roger Finn, Montgomery, OH (US); Henry Charles McGuigan, Duanesburg, NY (US); Brandon Scott Pieroni, Fayetteville, NC (US)

(21) Appl. No.: 18/619,670

(22) Filed: Mar. 28, 2024

(51) Int. Cl. B32B 3/04; B32B 3/12; B32B 3/26; B32B 3/30; B32B 9/00; B32B 9/04; B33Y 80/00

(52) U.S. Cl. CPC B32B 3/04; B32B 3/12; B32B 3/263; B32B 3/30; B32B 9/005; B32B 9/04; B33Y 80/00; B32B 2250/40; B32B 2307/72

(57) ABSTRACT

A composite panel includes a core structure having a main body and an attachment portion integrally formed with the main body. The core structure further includes at least one face. The attachment portion defines a first portion of an attachment aperture. The composite panel further includes a composite sheet that is bonded to the least one face of the core structure. The composite sheet extends between the main body and the attachment portion. The composite sheet defines a second portion of the attachment aperture.

### FIELD

The present disclosure relates to composite panels, and more particularly, composite panels having core structures with a plurality of hollow cells.

### BACKGROUND

Modern machinery such as airplanes, automobiles, marine, rockets, space vehicles or industrial equipment may be subject to extreme operating conditions that include high temperatures, high pressure, and high speeds. Reinforced ceramic matrix composites (“CMCs”) comprising fibers dispersed in continuous ceramic matrices of the same or a different composition are well suited for structural applications because of their toughness, thermal resistance, high-temperature strength, and chemical stability. Such composites typically have high strength-to-weight ratio and maintain this attribute over a broad range of temperatures that exceeds metallic alloys. This renders them attractive in applications in which weight is a concern and high temperature structural attributes highly constrain the design of components and systems, such as in aeronautics and space vehicle applications. Their stability at high temperatures renders CMCs very suitable in applications in which components are in contact with a high-temperature gas, such as in a gas turbine engine and re-entry conditions of space vehicles in terrestrial and non-terrestrial environments.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates an exploded perspective view of an exemplary composite panel with a plurality of cells, the cells being in a hexagonal shape, in accordance with embodiments of the present disclosure;

FIG. 2 illustrates a top down view of another exemplary core structure of a composite panel in accordance with exemplary aspects of the present disclosure;

FIG. 3 illustrates a cross-sectional view of another exemplary composite panel having a core structure that is hollow and includes an attachment portion in accordance with embodiments of the present disclosure;

FIG. 4 illustrates a cross-sectional view of another exemplary composite panel having a core structure that is hollow and includes an attachment portion in accordance with embodiments of the present disclosure;

FIG. 5 illustrates a cross-sectional view of another exemplary composite panel having a core structure that is solid and includes an attachment portion in accordance with embodiments of the present disclosure;

FIG. 6 illustrates a cross-sectional view of another exemplary composite panel having a core structure that is hollow and includes an attachment portion in accordance with embodiments of the present disclosure;

FIG. 7 illustrates a cross-sectional view of another exemplary composite panel assembly having a first composite panel and a second composite panel in contact with one another such that their respective attachment apertures align, in accordance with embodiments of the present disclosure;

FIG. 8 is a perspective view of a core structure of an exemplary composite panel in accordance with embodiments of the present disclosure;

FIG. 9 is a plan view of the core structure shown in FIG. 8 in accordance with embodiments of the present disclosure;

FIG. 10 is a perspective view of another exemplary core structure of a composite panel in accordance with embodiments of the present disclosure;

FIG. 11 is a plan view of the core structure shown in FIG. 10 in accordance with embodiments of the present disclosure;

FIG. 12 is a perspective view of another exemplary core structure of a composite panel in accordance with embodiments of the present disclosure;

FIG. 13 is a plan view of the core structure shown in FIG. 12 in accordance with embodiments of the present disclosure; and

FIG. 14 is a flowchart diagram of an exemplary method of manufacturing a composite panel in accordance with embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and systems. In at least some instances, the approximating language may correspond to the precision of an instrument for measuring the value, or the precision of the methods or machines for constructing or manufacturing the components and systems. For example, the approximating language may refer to being within a 1, 2, 4, 5, 10, 15, or 20 percent margin in either individual values, range(s) of values and endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the terms “first”, “second”, and “third” may be used interchangeably to distinguish one component from another and are not intended to signify location or importance of the individual components.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

As used herein, the term “integral” as used to describe a structure refers to the structure being formed of a continuous material or group of materials with no seams, connections joints, or the like. The integral structure described herein may be formed through additive manufacturing to have the described structure, or alternatively through a casting process, etc. The term “unitary” as used herein denotes that the final component has a construction in which the integrated portions are inseparable and is different from a component comprising a plurality of separate component pieces that have been joined together but remain distinct and the single component is not inseparable (i.e., the pieces may be re-separated). Thus, unitary components may comprise generally substantially continuous pieces of material or may comprise a plurality of portions that are permanently bonded to one another. In any event, the various portions forming a unitary component are integrated with one another such that the unitary component is a single piece with inseparable portions.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, ceramic matrix composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon, silicon carbide, zirconium carbide), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

In certain embodiments, the reinforcing fibers may be bundled or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine, space vehicle structure, and propulsion components used in higher temperature sections, such as airfoils (e.g., turbines, and vanes), combustors, shrouds and other like components, nozzles, transition ducts, thermal protection systems, TPS, aerodynamic control surfaces and leading edges that would benefit from the lighter-weight and higher temperature capability these materials can offer.

As used herein, the term “additive manufacturing” refers generally to manufacturing technology in which components are manufactured in a layer-by-layer manner. An exemplary additive manufacturing machine may be configured to utilize any suitable additive manufacturing technology. The additive manufacturing machine may utilize an additive manufacturing technology that includes a powder bed fusion (PBF) technology, such as a direct metal laser melting (DMLM) technology, a selective laser melting (SLM) technology, a directed metal laser sintering (DMLS) technology, or a selective laser sintering (SLS) technology. In an exemplary PBF technology, thin layers of powder material are sequentially applied to a build plane and then selectively melted or fused to one another in a layer-by-layer manner to form one or more three-dimensional objects. Additively manufactured objects are generally monolithic in nature and may have a variety of integral sub-components.

Additionally or alternatively suitable additive manufacturing technologies may include, for example, Binder Jet technology, Fused Deposition Modeling (FDM) technology, Direct Energy Deposition (DED) technology, Laser Engineered Net Shaping (LENS) technology, Laser Net Shape Manufacturing (LNSM) technology, Direct Metal Deposition (DMD) technology, Digital Light Processing (DLP) technology, and other additive manufacturing technologies that utilize an energy beam or other energy source to solidify an additive manufacturing material such as a powder material. In fact, any suitable additive manufacturing modality may be utilized with the presently disclosed the subject matter.

Additive manufacturing technology may generally be described as fabrication of objects by building objects point-by-point, line-by-line, layer-by-layer, typically in a vertical direction. Other methods of fabrication are contemplated and within the scope of the present disclosure. For example, although the discussion herein refers to the addition of material to form successive layers, the presently disclosed subject matter may be practiced with any additive manufacturing technology or other manufacturing technology, including layer-additive processes, layer-subtractive processes, or hybrid processes.

The additive manufacturing processes described herein may be used for forming components using any suitable material. For example, the material may be metal, ceramic, polymer, epoxy, photopolymer resin, plastic, or any other suitable material that may be in solid, powder, sheet material, wire, or any other suitable form, or combinations thereof. Additionally, or in the alternative, exemplary materials may include metals, ceramics, or binders, as well as combinations thereof. Exemplary ceramics may include ultra-high-temperature ceramics, or precursors for ultra-high-temperature ceramics, such as polymeric precursors. Each successive layer may be, for example, between about 10 μm and 200 μm, although the thickness may be determined based on any number of parameters and may be any suitable size.

As used herein, the term “build plane” refers to a plane defined by a surface upon which an energy beam impinges to selectively irradiate and thereby consolidate powder material during an additive manufacturing process. Generally, the surface of a powder bed defines the build plane. During irradiation of a respective layer of the powder bed, a previously irradiated portion of the respective layer may define a portion of the build plane. Prior to distributing powder material across a build module, a build plate that supports the powder bed generally defines the build plane.

As used herein, the term “consolidate” or “consolidating” refers to densification and solidification of powder material as a result of irradiating the powder material, including by way of melting, fusing, sintering, or the like.

Of particular interest in the field of CMCs is the joining of one CMC subcomponent, or preform, to another CMC or ceramic subcomponent to form a complete component structure. For instance, the joining of one CMC subcomponent to another may arise when the shape complexity of an overall complete structure may be too complex to lay-up as a single part. Another instance where joining of one CMC subcomponent to another may arise is when a large complete structure is difficult to lay-up as a single part, and multiple subcomponents, or preforms, are manufactured and joined to form the large complete structure. Fabrication of complex composite components may require complex tooling, and may involve forming fibers over small radii, both of which lead to challenges in manufacturability. Current procedures for bonding CMC subcomponents include, but are not limited to, diffusion bonding, reaction forming, melt infiltration, brazing, adhesives, or the like. Of particular concern in these CMC component structures that are formed of conjoined subcomponents is the separation, or failure, of the joint that is formed during the joining procedure, when under the influence of applied loads.

Thus, an improved joint and method of joining one CMC subcomponent, or preform, to another ceramic monolithic subcomponent or CMC subcomponent to form a complete structure. The resulting joint providing strength and toughness to the structure that can withstand the influence of applied loads.

The present disclosure is generally related to composite panels that are constructed from composite materials. A core of the composite panel can be solid or include a plurality of hollow cells. While composite materials provide good toughness, high thermal insulation, high-temperature strength, and chemical stability, the raw material and processing techniques can become expensive. Current structures capable of withstanding extreme operation conditions may be bulky, expensive, or have short lifespans. Accordingly, a lighter, stronger, and more cost-effective structure would be welcomed in the art. Composite panels can provide for similar properties while reducing weight of a component formed from there construction, with respect to other materials (e.g., superalloys). However, the relatively thin walls of the core structure provide limited bonding area to connect the core structure with one or more face sheets.

The present disclosure provides composite panels having core structures with attachment portions that facilitate coupling of the composite panel to other components. The attachment portions may include increased thickness to provide additional structural integrity to the composite panel, which advantageously prevents joint failure or separation of the core structure from the composite sheets. Particularly, the core structures may be additively manufactured having the attachment portions, which minimizes machining of the final composite panel and provides for better integration of the attachment portion to the composite sheets.

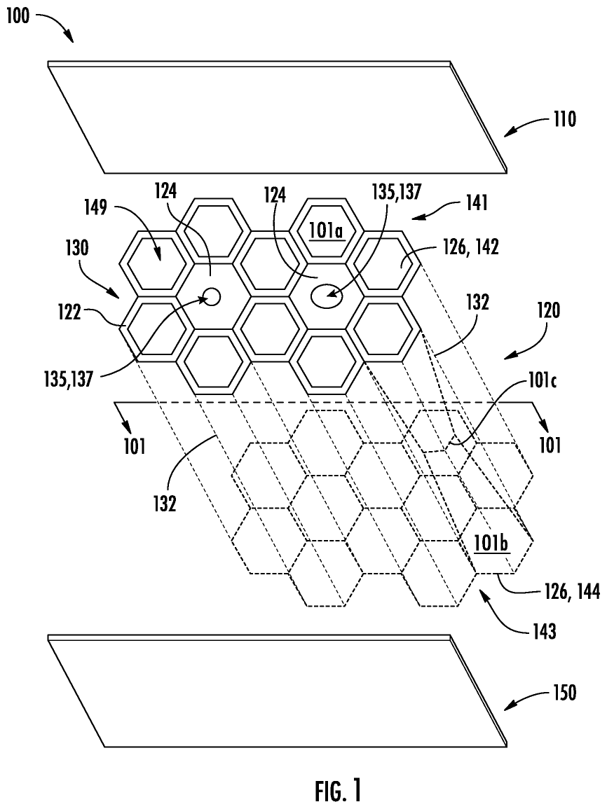

Referring now to the drawings, in which identical numerals indicate the same elements or similar elements in different embodiments throughout the figures, FIG. 1 shows an exploded view of composite panel 100 according to one or more embodiments described herein. The composite panel 100 generally comprises a core structure 120 and a first composite sheet 110 bonded to a first side 141 (or top side) of the core structure 120. In some embodiments, such as that illustrated in FIG. 1, the composite panel 100 may further comprise a second composite sheet 150 bonded to a second side 143 (or bottom side) of the core structure 120 and opposite the first side 141. The core structure 120 may include a main body 122 and an attachment portion 124 formed integrally with the main body. The attachment portion 124 may define a first portion 135 of an attachment aperture 137. Additionally, the main body 122 may define at least one face 126, such as a first face 142 (or top face) and a second face 144 (or bottom face). The core structure 120 may also include a cross-sectional geometry 101 that is nonuniform in a height direction between the first face 142 of the first side 141 and the second face 144 of the second side 143. Such a configuration can provide the first face 142 of the core structure 120, the second side 143 of the core structure 120, or a combination thereof to produce greater bonding with the first composite sheet 110, the second composite sheet 150, or a combination thereof where present while also producing a lighter composite panel 100 compared to a completely solid composite material.

The first composite sheet 110, the second composite sheet 150, and the core structure 120 can comprise a combination of different materials to facilitate structural and mechanical requirements for the composite panel 100. The first composite sheet 110 and the second composite sheet 150 (as well as the composite sheets 202, 204, and 206 discussed below with reference to FIGS. 5 through 7) can comprise any composite material. By way of non-limiting example, the composite material can include a CMC that generally comprises a fibrous reinforcement material embedded in matrix material. The reinforcement material serves as a load-bearing constituent of the CMC, while the matrix of a composite material serves to bind the fibers together and act as the medium by which an externally applied stress is transmitted and distributed to the fibers. Generally, CMCs are well suited for structural applications because of their toughness, thermal resistance, high-temperature strength, and chemical stability. Such composites may have high strength-to-weight ratio that renders them attractive in applications in which weight is a concern, such as in aeronautic applications. Further, their stability at high temperatures renders CMCs very suitable in applications in which components are in contact with a high-temperature gas, such as within a gas turbine engine.

Exemplary CMC materials may include silicon carbide (SiC), silicon, silica, carbon, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., 3M's Nextel 440 and 480), and chopped whiskers and fibers (e.g., 3M's Nextel 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together (e.g., as plies) to form a preform component. The bundles of fibers may be impregnated with a slurry composition prior to forming the preform (e.g., prepreg plies) or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition. In other embodiments, the CMC material may be formed as, e.g., a carbon fiber cloth rather than as a tape.

In one non-limiting example, the core structure 120 may comprise a different material compared to the first composite sheet 110 or the second composite sheet 150, such as an unreinforced ceramic material (e.g., a ceramic material free from ceramic fibers). Similarly, the core structures 190 and 230 discussed below with reference to FIGS. 5 through 7 may be formed from a different material compared to the composite sheets 202, 204, 206. By way of non-limiting example, the core structure 120 may be a material that is less dense than the material of the first composite sheet 110 or the second composite sheet 150. However, even when the material of the core structure 120 is different, it is compatible with the first composite sheet 110 and the second composite sheet 150 to produce a sufficient bond between the components, including in extreme operating conditions such as high temperatures. In exemplary embodiments, the core structure 120 may include silicon, silicon carbide, alumina, carbon, or aluminosilicates, or combinations thereof. However, some embodiments, the core structure 120 may comprise the same material as the first composite sheet 110 or the second composite sheet 150.

As illustrated in FIG. 1, the core structure 120 comprises a plurality of hollow cells 130 defined by a plurality of lattice walls 132 extending from a first face 142 on a top side 141 to a second face 144 on a bottom side 143. In one non-limiting example, each of the plurality of hollow cells 130 that form the core structure 120 can extend in a parallel direction with one another. In other embodiments, one or more of the plurality of hollow cells may converge in cross-sectional area between the first face 142 and the second face 144. Moreover, each first face 142 for each of the plurality of hollow cells 130 may be planar with one another so that the top side 141 of the core structure 120 comprises a substantially flat plane comprising a plurality of first faces 142 from the plurality of hollow cells 130. Likewise, each second face 144 for each of the plurality of hollow cells 130 may be planar with one another so that the bottom side 143 of the core structure 120 comprises a substantially flat plane comprising a plurality of second faces 144 from the plurality of hollow cells 130. In such embodiments, the first faces 142 and the second faces 144 may be parallel with one another such the first composite sheet 110 being bonded to the top side 141 of the core structure 120 will be parallel with the second composite sheet 150 being bonded to the bottom side 143 of the core structure 120.

While the core structure 120 in FIG. 1 is illustrated as having a plurality of hollow cells 130 that are parallel with one another, are the same length as one another, and comprise a top side 141 parallel with a bottom side 143, it should be appreciated that a variety of alternative or additional configurations may also be realized within the scope of this disclosure. For example, the plurality of hollow cells 130 may comprise different lengths, may comprise different orientations, may produce top sides 141 and bottom sides 143 that are not planar or not parallel with one another, or any combination thereof.

As illustrated in FIG. 1, the plurality of lattice walls 132 of the plurality of hollow cells 130 define the shape, and more specifically, the cross-sectional geometry 101, of each of the plurality of hollow cells 130. That is, the plurality of lattice walls 132 create a partially closed structure (i.e., enclosed by the plurality of lattice walls 132 on the side but potentially open on the ends at the first face 142 or the second face 144) to define a hollow interior 149 to form a cross-sectional geometry 101 for each of the plurality of cells. As used herein, the cross-sectional geometry 101 refers to the open, or closed, space between the plurality of lattice walls 132 at any point along the length of any individual cell. For example, each cell 130 has a top cross-sectional geometry 101a at its first face 142 at the top side 141 of the core structure 120, and a bottom cross-sectional geometry 101b at its second face 144 at the bottom side 143 of the core structure 120. The plurality of lattice walls 132 may be brought together to form the plurality of hollow cells 130 using a variety of different techniques. For instance, as a non-limiting example, the plurality of lattice walls 132 may be unitarily formed, monolithically formed, or unitarily and monolithically formed.

The cross-sectional geometry 101 can comprise a variety of different shapes within each of the plurality of hollow cells 130. For example, as shown in the embodiment of FIG. 1, the cross-sectional geometry 101 of each hollow cell 130 may be a hexagon. That is, each hollow cell 130 of the plurality of hollow cells 130 may have a hexagonal shape. However, the plurality of hollow cells 130 may have cross-sectional geometries 101 that are different, e.g., where the cross-sectional geometry 101 is one of a hexagon, circle, square, or a triangle in non-limiting examples.

FIG. 2 illustrates a top down view of a core structure 120 of an exemplary composite panel 100′ in accordance with embodiments of the present disclosure. As shown, the core structure 120 may include the main body 122 having an attachment portion 124 integrally positioned therein. The attachment portion 124 may extend from the main body 122 or may form a part of the main body 122. Additionally, the main body 122 may define at least one face 126, such as the first face 142 and the second face 144 discussed above with reference to FIG. 1. It will be appreciated that components of the composite panel 100′ shown in FIG. 2 that are similar to those of the composite panel 100 of FIG. 1 will share a common numeral, and description of those components will be common to both composite panels 100, 100′.

In exemplary embodiments, the attachment portion 124 may be integrally positioned within the main body 122. That is, the attachment portion 124 and the main body 122 may be integrally formed as a single component. For example, the attachment portion 124 and the main body 122 may be manufactured together as a single body. In exemplary embodiments, this may be done by utilizing an additive manufacturing system. The integral formation the attachment portion 124 with the main body, e.g., through additive manufacturing, may advantageously improve the overall strength of the core structure 120. Additionally, existing issues with, for example, leakage, joint quality between separate parts, and overall performance may advantageously be reduced.

In various embodiments, the main body 122 may include end walls 123, which may be spaced apart and generally parallel to one another. Additionally, the main body 122 may include side walls 125 extending between the end walls 123. The side walls 125 may be generally parallel to one another and perpendicular to the end walls 123. Further, the main body 122 may include a plurality of lattice walls 132 that at least partially define a plurality of hollow cells 130. The plurality of hollow cells 130 may each define a cross-sectional geometry (e.g., in the longitudinal-transverse plane), which may be shaped as a hexagon (either a full hexagon or a portion of a hexagon). However, the plurality of hollow cells 130 may have other shapes, such as triangular, circular, rectangular, or others.

In many embodiments, each of the lattice walls 132 of the plurality of lattice walls may extend from one of the attachment portion 124, one of the end walls 123, one of the side walls 125, or another lattice wall 132 of the plurality of lattice walls 132. In this way, in addition to the lattice walls 132, the attachment portion 124, the side walls 125, and the end walls 123 may collectively define one or more of the hollow cells 130. For example, as shown in FIG. 2, one or more hollow cells 130 of the plurality of hollow cells 130 may be defined collectively by the attachment portion 124 and a set of lattice walls 132 of the plurality of lattice walls 132.

Additionally, as shown, one or more hollow cells 130 of the plurality of hollow cells 130 may be defined collectively by one of the end walls 123 and one or more lattice walls 132 of the plurality of lattice walls 132. Further, one or more hollow cells 130 may be defined collectively by one of the side walls 125 and one or more lattice walls 132 of the plurality of lattice walls 132. Additionally, one or more hollow cells 130 may be defined collectively by the attachment portion 124 and one or more lattice walls 132 of the plurality of lattice walls 132.

In exemplary embodiments, the attachment portion 124 may define the first portion 135 of the attachment aperture 137. The attachment aperture 137 may be sized and oriented to receive a fastening element (such as a bolt or other fastening element). In many embodiments, as shown, the attachment aperture 137 may have a circular cross-sectional shape; however, this need not be the case. The attachment aperture 137 may have other cross-sectional shapes, such as a non-circular cross-sectional shape. For example, referring back to FIG. 1 briefly, as shown, the attachment aperture 137 may have either a circular or a non-circular shape. In embodiments in which the attachment aperture 137 has a non-circular shape, the attachment aperture 137 may have an elliptical, geometric stadium (e.g., a rectangle having semi-circular ends), or others cross-sectional shapes. The non-circular cross sectional shape may be advantageous due to non-uniform thermal expansion/retraction of the core structure 120 and the entire composite panel 100.

Referring back to FIG. 2, the attachment portion 124 may have the same cross-sectional shape as the plurality of hollow cells 130 (e.g., hexagonal). In the illustrated exemplary embodiment, the attachment portion may define six corners, and a lattice wall 132 may extend from each corner of the six corners. In other embodiments (not shown), the attachment portion 124 may have a different cross-sectional shape than the plurality of hollow cells 130.

In many embodiments, each of the lattice walls 132 may define a first thickness 160. Particularly, each of the lattice walls 132 may define a first surface 161 and a second surface 163 opposite the first surface 161, and the first thickness 160 may be defined between the first surface 161 and the second surface 163. Similarly, the attachment portion 124 may define a second thickness 162. The second thickness may be defined between the first portion 135 of the attachment aperture 137 and an outer surface 180 of the attachment portion 124. The outer surface 180 may be defined by the attachment portion 124. As shown in FIG. 2, the second thickness 162 may vary about the circumference of the first portion 135 of the attachment aperture 137 (e.g., the thickness may increase near the corners of the hexagonally shaped attachment portion 124) The second thickness 162 may be larger than the first thickness 160. For example, the second thickness 162 may be between about 5% and about 450% larger than the first thickness 160, or such as between about 10% and about 300% larger than the first thickness 160, or such as between about 20% and about 200% larger than the first thickness 160, or such as between about 40% and about 100% larger than the first thickness 160. The additional thickness of the attachment portion 124 may advantageously provide additional structural support and strength that allows the attachment portion 124 to support a joint (such as a bolted joint, a welded joint, or others).

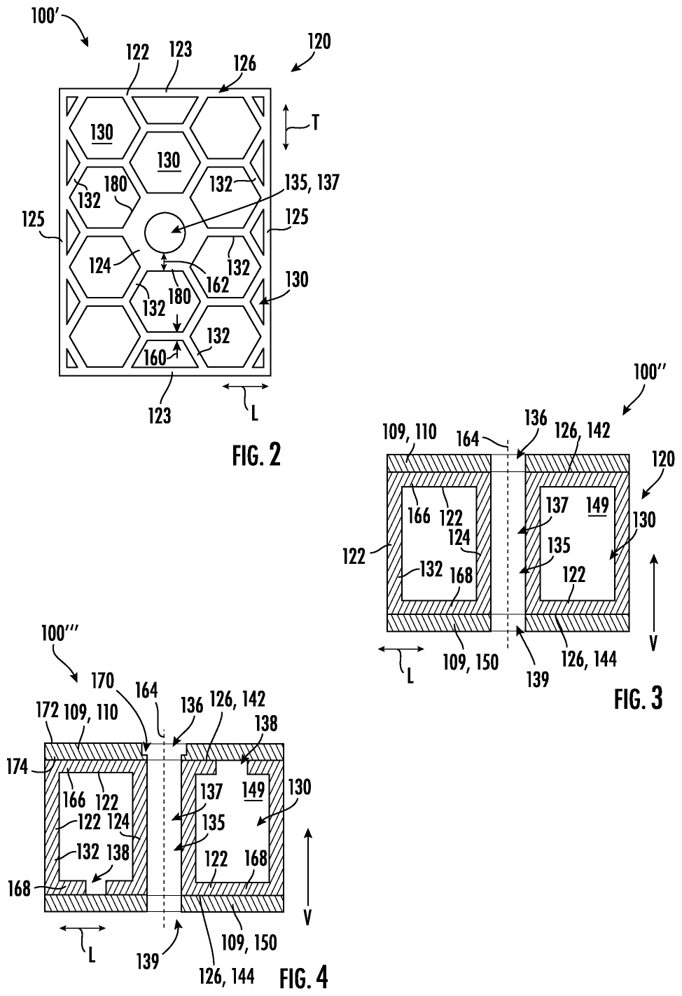

FIG. 3 illustrates a cross-sectional view of an exemplary composite panel 100″, in accordance with an embodiment of the present disclosure. FIG. 4 illustrates a cross-sectional view of a similar exemplary composite panel 100′″, in accordance with an embodiment of the present disclosure. As shown by FIGS. 2 through 4 collectively, each respective composite panel 100′, 100″, 100′″ may define a cartesian coordinate system having a vertical direction V, a longitudinal direction L, and a transverse direction T mutually perpendicular to one another. As shown, each composite panel 100′, 100″, 100′″ may include the core structure 120 and a composite sheet 109. Particularly, each composite panel 100′, 100″, 100′″ may include a first composite sheet 110, and a second composite sheet 150. As discussed above, the core structure 120 may include an attachment portion 124 and a main body 122 having a plurality of lattice walls 132. The core structure 120 may define at least one face 126, and the composite sheet 109 may be bonded to the least one face 126 of the core structure 120. Particularly, the at least one face 126 includes the first face 142 (or top face) and the second face 144 (or bottom face). The first composite sheet 110 may be bonded to the first face 142, and the second composite sheet 150 may be bonded to the second face 144.

The composite sheet 109 may extend between the main body 122 and the attachment portion 124 of the core structure 120 (e.g., on the at least one face 126). As shown in FIGS. 3 and 4, the attachment aperture 137 may be defined collectively by the core structure 120, the first composite sheet 110, and the second composite sheet 150. That is, the attachment portion 124 of the core structure 120 may define the first portion 135 of the attachment aperture 137. The first portion 135 of the attachment aperture may extend vertically from the first face 142 to the second face 144. The first composite sheet may define a second portion 136 of the attachment aperture 137, and the second composite sheet may define a third portion 139 of the attachment aperture 137.

As shown in FIGS. 3 and 4, the first portion 135, the second portion 136, and the third portion 139 of the attachment aperture 137 may align along a common axis 164. The common axis 164 may extend vertically. A center point of each of the first portion 135, the second portion 136, and the third portion 139 may be positioned along the common axis 164.

As discussed above, the main body 122 may include a plurality of lattice walls 132 that at least partially define a plurality of hollow cells 130. As shown in FIGS. 3 and 4, each of the hollow cells 130 may be formed collectively by a lattice wall 132, the attachment portion 124, a first wall 166 (or top wall), and a second wall 168 (or bottom wall). In some embodiments (not shown), one or more of the hollow cells 130 may not include a first wall 166 and a second wall 168, such that the one or more hollow cells 130 may have an open end (e.g., be open at the first face 142 or the second face 144). The first wall 166 and the second wall 168 may be generally perpendicular to the lattice wall 132. For example, each lattice wall 132 may extend generally vertically from the second wall 168 to the first wall 166, and the top wall may extend longitudinally (and transversely) from one or more lattice walls 132 to the attachment portion 124.

Each hollow cell 130 of the plurality of hollow cells 130 may define a hollow interior 149. That is, the hollow interior 149 may be defined collectively by the first wall 166, the second wall 168, the attachment portion 124, and one or more lattice walls 132 of the plurality of lattice walls 132.

FIG. 4 illustrates that the first wall 166 or the second wall 168 may define an opening 138 or open face or to facilitate for the removal of powder feedstock from a potentially otherwise enclosed hollow interior. An opening can be included at both sides. Further still, openings need not be on alternating sides and may be on a single face of the main body.

As shown in FIG. 4, the composite sheet 109 (e.g., the first composite sheet 110) may include a recess 170. Particularly, the first composite sheet 110 may include a first surface 172 and a second surface 174. The recess 170 may extend from the first surface 172 through the second surface 174. Particularly, the recess 170 may extend from the first surface 172 to the second portion 136 of the attachment aperture 137, and the second portion 136 of the attachment aperture 137 may extend from the recess to the second surface 174 of the first composite sheet 110. The recess 170 may define a first width (or diameter), and the attachment aperture 137 may define a second width (or diameter, if circular in nature). The first width may be larger than the second width. The recess 170 may be configured to receive and house a portion of a fastener, such as by way of non-limiting example a bolt head, such that the bolt head may be lower than or flush with the first surface 172 of the first composite sheet 110 when the fastener is inserted into the attachment aperture 137.

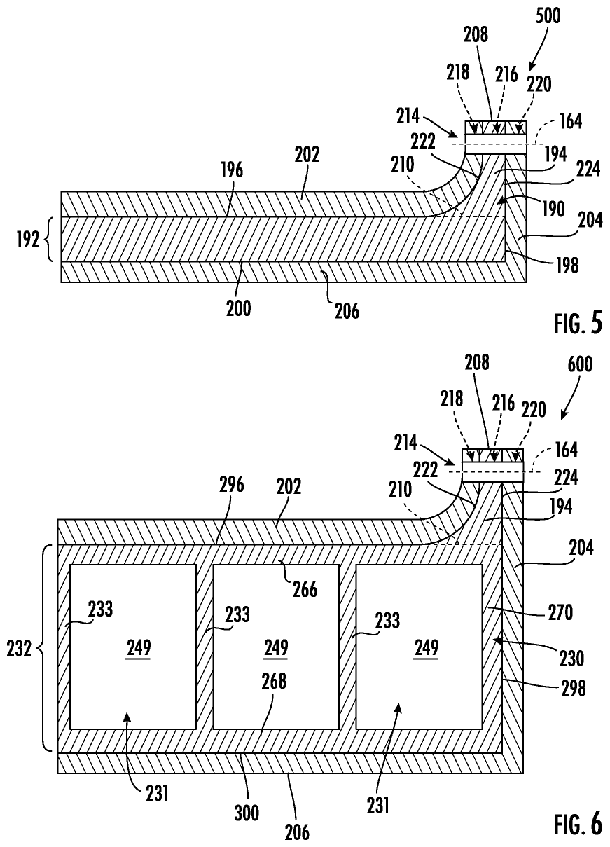

In the embodiments shown in FIGS. 3 and 4, the attachment portion 124 and the attachment aperture 137 may extend along a common axis 164 that is generally parallel to the vertical direction V and generally parallel to the lattice walls 132 (e.g., between the first face 142 and the second face 144). However, in other embodiments, as shown in FIGS. 5 and 6, an attachment aperture 214 may extend along a common axis 164 that is not parallel to the vertical direction V or to lattice walls 233.

FIG. 5 illustrates a cross-sectional view of a composite panel 500, and FIG. 6 illustrates a cross-sectional view of a composite panel 600 in accordance with embodiments of the present disclosure. Particularly, FIG. 5 illustrates a composite panel 500 having a core structure 190 with a main body 192 that is solid. As used herein, “solid” may refer to a component or components that are free of voids, internal cavities, holes, etc. The main body 192 may include a first face 196 (e.g., a top face), a second face 198 (e.g., a side face), and a third face 200 (e.g., a bottom face) opposite the first face 196.

An attachment portion 194 extends away from the main body 192. In exemplary embodiments, as shown in FIG. 5, the attachment portion 194 may extend away from the main body 192 to a terminal end 208. In a non-limiting example, the attachment portion 194 may extend from the first face 196 of the main body 192 to the terminal end 208. The attachment portion 194 may extend vertically from a base 210 to a terminal end 208. In one example, the base 210 (illustrated with the dashed line) may be coupled to the first face 196 of the main body 192, and the terminal end 208 may be a free end (e.g., not coupled to another component). Alternatively, the attachment portion and the main body 192 can be unitarily formed such that the base 210 is integral with the main body 192.

The attachment portion 194 may define a first surface 222, an second surface 224, and the terminal end 208 extending between the first surface 222 and the second surface 224. As shown in FIG. 5, the first surface 222 may include a curved portion and a straight portion. The curved portion may extend from the first face 196 of the main body 192 to the straight portion, and the straight portion may extend from the curved portion to the terminal end 208. The attachment portion 194 may define a width between the first surface 222 and the second surface 224, and the attachment portion 194 may converge in width as the attachment portion extends away from the main body 192 to the terminal end 208.

The composite panel 500 may include a first composite sheet 202, a second composite sheet 204, and a third composite sheet 206. The first composite sheet 202 may be bonded to a first face 196 of the main body 192 and the first surface 222 of the attachment portion 194. The second composite sheet 204 may be bonded to the second face 198 of the main body 192 and the second surface 224 of the attachment portion 194. The third composite sheet 206 may be bonded to the third face 200 of the main body 192.

As shown in FIG. 5, an attachment aperture 214 may be disposed through a section of the attachment portion 194. Additionally, an unreinforced section of the attachment portion 194 has an increased local thickness to accommodate the curvature of the first composite sheet 202, thereby extending from the first composite sheet 202 to the second composite sheet 204 and to the third composite sheet 206. In the illustrated example, the attachment portion 194 forms a flange having an opening therethrough. Particularly, the attachment aperture 214 may be defined collectively by the first composite sheet 202, the attachment portion 194 of the core structure 190, and the second composite sheet 204. For example, the attachment portion 194 may define a first portion 216 of the attachment aperture 214. The first portion 216 of the attachment aperture 214 may extend from the first surface 222 to the second surface 224 of the attachment portion 194. The first composite sheet 202 may define a second portion 218 of the attachment aperture 214, and the second composite sheet 204 may define a third portion 220 of the attachment aperture 214. The first portion 216, the second portion 218, and the third portion 220 may align with one another to collectively form the attachment aperture 214 that is configured to receive a bolt or other attachment mechanisms.

As shown in FIG. 6, the composite panel 600 may include a core structure 230 having a main body 232 that is hollow. That is, the main body 232 may include a plurality of hollow cells 231, which may have the same or a similar structure to the hollow cells 130 discussed above with reference to FIGS. 1 through 4.

The main body 232 may include a plurality of lattice walls 233 that at least partially define a plurality of hollow cells 231. As shown, each of the hollow cells 231 may be formed collectively by a lattice wall 233, a top wall 266, and a bottom wall 268. At least one hollow cell 231 may be formed collectively by a lattice wall 233, a top wall 266, a bottom wall 268, and an end wall 270. In some embodiments (not shown), one or more of the hollow cells 130 may not include the top wall 266 or a bottom wall 268, such that the one or more hollow cells 231 may have an open end (e.g., be open at the first face 142 or the second face 144). The top wall 266 and the bottom wall 268 may be generally perpendicular to the lattice walls 233 and perpendicular to the end wall 270. For example, each lattice wall 233 may extend generally vertically from the bottom wall 268 to the top wall 266.

Each hollow cell 231 of the plurality of hollow cells 231 may define a hollow interior 249. That is, the hollow interior 249 may be defined collectively by the top wall 266, the bottom wall 268, and one or more lattice walls 233 of the plurality of lattice walls 233. In some embodiments, the top wall 266 or the bottom wall 268 may define an opening or open face or to facilitate for the removal of powder feedstock from a potentially otherwise enclosed hollow interior.

The core structure 230 may further include an attachment portion 194 extending from the main body 232. The main body 232 may include a first face 296 (e.g., a top face), a second face 298, a third face 300 (e.g., a bottom face) opposite the first face 296. Of course, depending on the design of the core structure 230, other faces may be present. The first face 296 may be at least partially defined by the top wall 266, and the third face 300 may be at least partially defined by the bottom wall 268. The main body 232 of the core structure 230 may further include a second face 298 (e.g., a side face) defined at least partially by the end wall 270. The end wall 270 may have a similar structure as the lattice walls 233 or may be thicker than the lattice walls 233.

The attachment portion 194 may define a first surface 222, a second surface 224, and the terminal end 208 extending between the first surface 222 and the second surface 224. The first surface 222 may include a curved portion and a straight portion. The curved portion may extend from the first face 296 of the main body 232 to the straight portion, and the straight portion may extend from the curved portion to the terminal end 208. The attachment portion 194 may define a width between the first surface 222 and the second surface 224, and the attachment portion 194 may converge in width as the attachment portion extends away from the main body 232 to the terminal end 208.

The attachment portion 194 may extend from the main body 232 to a terminal end 208. Particularly, the attachment portion 194 may extend from the first face 296 of the main body 232 to the terminal end 208. The attachment portion 194 may extend vertically from a base 210 to the terminal end 208. The base 210 may be coupled to the first face 296 of the main body 232, and the terminal end 208 may be a free end (e.g., not coupled to another component). The attachment portion 194 may extend from the main body 232 to the terminal end 208 at the end wall 270 of the main body 232, such that the second surface 224 of the attachment portion 194 extends from the second face 298 of the main body 232 of the core structure 230.

The composite panel 600 may include a first composite sheet 202, a second composite sheet 204, and a third composite sheet 206. The first composite sheet 202 may be bonded to the first face 296 of the main body 232 and the first surface 222 of the attachment portion 194. The second composite sheet 204 may be bonded to the second face 298 of the main body 232 and the second surface 224 of the attachment portion 194. The third composite sheet 206 may be bonded to the third face 300 of the main body 122.

In many embodiments, the attachment portion 194 may define an angle with the main body 232. For example, while FIG. 6 illustrates the attachment portion 194 extending generally perpendicularly from the main body 232, such that the angle between the main body 232 and the attachment portion 194 is about 90°. In other embodiments, the angle may be between about 0° and about 180°, or such as between about 20° and about 160°, or such as between about 40° and about 120°, or such as between about 60° and about 100°.

As shown in FIG. 6, an attachment aperture 214 may be disposed between the main body 232 and the terminal end 208 of the attachment portion 194. Particularly, the attachment aperture 214 may be defined collectively by the first composite sheet 202, the attachment portion 194 of the core structure 230, and the second composite sheet 204. For example, the attachment portion 194 may define a first portion 216 of the attachment aperture 214. The first portion 216 of the attachment aperture 214 may extend from the first surface 222 to the second surface 224 of the attachment portion 194. The first composite sheet 202 may define a second portion 218 of the attachment aperture 214, and the second composite sheet 204 may define a third portion 220 of the attachment aperture 214. The first portion 216, the second portion 218, and the third portion 220 may align with one another to collectively form the attachment aperture 214 that is configured to receive a bolt or other attachment mechanisms.

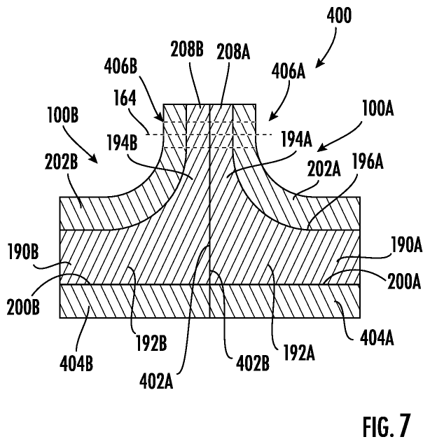

FIG. 7 illustrates a cross-sectional view of a composite panel assembly 400 in accordance with embodiments of the present disclosure. As shown, the composite panel assembly 400 includes a first composite panel 100A and a second composite panel 100B contacting one another to form a joint therebetween. The first composite panel 100A and the second composite panel 100B may each be configured similarly to the composite panel 100 discussed above with reference to FIG. 5.

The first composite panel 100A may include a first core structure 190A having a first main body 192A, a first attachment portion 194A, a first face 196A, and a first exposed face 402A. The first composite panel 100A may further include a first top composite sheet 202A bonded to the first face 196A of the first core structure 190A. Additionally, the first composite panel 100A may include a first bottom composite sheet 404A bonded to a first face 200A of the first core structure 190A. In exemplary embodiments, the first attachment portion 194A and the first top composite sheet 202A collectively define a first attachment aperture 406A.

The second composite panel 100B may include a second core structure 190B having a second main body 192B, a second attachment portion 194B, a second face 196B, and a second exposed face 402B. The second composite panel 100B may further include a second top composite sheet 202B bonded to the second face 196B of the second core structure 190B. Additionally, the second composite panel 100B may include a second bottom composite sheet 404B bonded to a second face 200B of the second core structure 190B. In exemplary embodiments, the second attachment portion 194B and the second top composite sheet 202B collectively define a second attachment aperture 406B.

As shown in FIG. 7, in exemplary embodiments, the first exposed face 402A and the second exposed face 402B may not be coupled to a composite sheet. Instead, the first exposed face 402A and the second exposed face 402B may contact one another such that the first attachment aperture 406A aligns with the second attachment aperture 406B. In many embodiments, a fastening member, such as a bolt, may be inserted through the first attachment aperture 406A and the second attachment aperture 406B to couple the first composite panel 100A to the second composite panel 100B.

In many embodiments, the first attachment portion 194A may extend away from the first main body 192A to a first terminal end 208A. In such embodiments, the first attachment aperture 406A may be disposed between the first main body 192A and the first terminal end 208A of the first attachment portion 194A. Similarly, as shown, the second attachment portion 194B may extend away from the second main body 192B to a second terminal end 208B. In such embodiments, the second attachment aperture 406B may be disposed between the second main body 192B and the second terminal end 208B of the second attachment portion 194B.

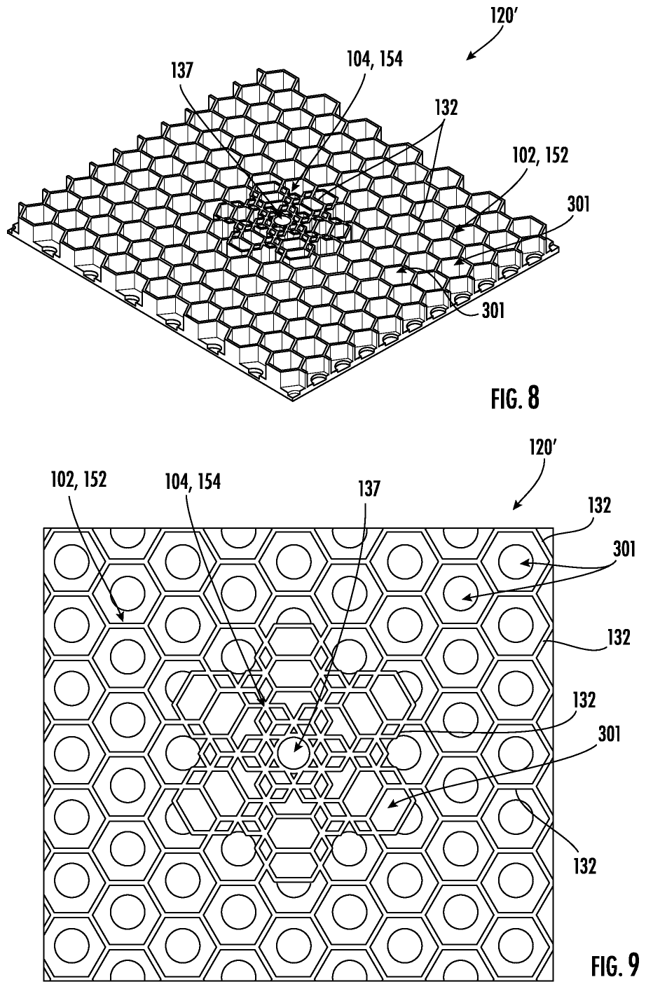

Referring now to FIGS. 8 through 13, various embodiments of core structures are illustrated in accordance with aspects of the present disclosure. Such core structures may be employed in the composite panels described above with reference to FIGS. 1 through 7. As shown in FIGS. 8 through 13, the core structure 120′, 120″, 120′″ may include a plurality of lattice walls 132 that define one or more patterns and hollow cavities. In some embodiments, such as is shown in FIG. 8, the respective core structure 120′, 120″ may include a main body 102 that defines a first lattice pattern 152 with the plurality of lattice walls 132 and an attachment portion 104 that defines a second lattice pattern 154 with the plurality of lattice walls 132 that is different than the first lattice pattern 152. In other embodiments, such as is shown in FIG. 12, the core structure 120′″ may include a main body 102 that defines a first lattice pattern 152 with the plurality of lattice walls 132 and an attachment portion 104 that defines a second lattice pattern 154 with the plurality of lattice walls 132 that is the same as the first lattice pattern 152 but has a larger lattice wall thickness.

The attachment portion 104 may have a material density that is greater than a material density of the main body 102. For example, the attachment portion 104 may have a material density that is between about 10% and about 300% greater than a material density of the main body 102, or such as between about 50% and about 250% greater than a material density of the main body 102, or such as between about 50% and about 150% greater than a material density of the main body 102. The difference in material density between the main body 102 and the attachment portion 104 may be accomplished by varying the distance between the lattice walls 132 in the main body 102 and the attachment portion 104 (e.g., by altering the pattern of lattice walls 132 for the main body 102 and the attachment portion 104) or by varying the thickness of the lattice walls 132 in the main body 102 and the attachment portion 104. Thus, more material may be present in the attachment portion 104 to provide greater strength therein, when compared to the main body 102.

Referring specifically to the embodiment shown in FIGS. 8 and 9, the main body 102 of the core structure 120′ may define a first lattice pattern 152 that is different than a second lattice pattern 154 of the attachment portion 104. In the first lattice pattern 152, the plurality of lattice walls 132 form a plurality of hexagonal units 301. Each hexagonal unit 301 may be formed by six lattice walls 132. Each hexagonal unit 301 may share lattice walls 132 with at least one other hexagonal unit 301. Particularly, each hexagonal unit 301 may share a lattice wall 132 with up to six other hexagonal units 301 and with the attachment portion 104. Furthermore, each hexagonal unit 301 in the first lattice pattern 152 may be an equal size (such that each of the lattice walls 132 making up a hexagonal unit 301 have an equal length).

The second lattice pattern 154 may include a plurality of overlapping hexagonal units 301, each hexagonal unit 301 in the second lattice pattern 154 may partially overlap with one or more hexagonal units 301, which results in a denser pattern than the first lattice pattern 152, thereby offering increased material strength proximate the attachment aperture 137 (which allows for a mechanical connection). Additionally, the hexagonal units 301 in the second lattice pattern 154 may have various sizes (such as a first size, a second size smaller than the first size, a third size smaller than the first and the second size, and so on), although this need not be the case.

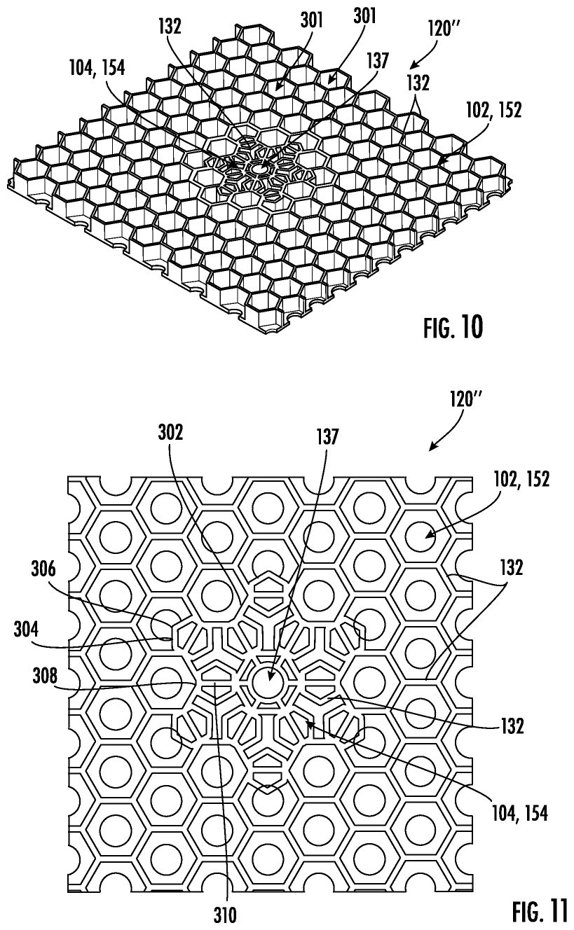

Referring specifically to the embodiment shown in FIGS. 10 and 11, the main body 102 of the core structure 120″ may define a first lattice pattern 152 that is different than a second lattice pattern 154 of the attachment portion 104. In the first lattice pattern 152, the plurality of lattice walls 132 form a plurality of hexagonal units 301. Each hexagonal unit 301 may be formed by six lattice walls 132. Each hexagonal unit 301 may share lattice walls 132 with at least one other hexagonal unit 301. Particularly, each hexagonal unit 301 may share a lattice wall 132 with up to six other hexagonal units 301 and with the attachment portion 104. Furthermore, each hexagonal unit 301 in the first lattice pattern 152 may be an equal size (such that each of the lattice walls 132 making up a hexagonal unit 301 have an equal length).

The second lattice pattern 154 may include a star shaped outer perimeter 302. Particularly, the star shaped outer perimeter 302 may include six outer vertices 306 and six inner vertices 308. The star shaped outer perimeter 302 may include tips 304 that at least partially overlaps with one or more hexagonal units 301 in the first lattice pattern 152. The tips 304 may define the outer vertices 306. The attachment aperture 137 may be defined in the center of the second lattice pattern 154. One or more support walls 310 may extend between the attachment aperture 137 and the inner vertices 308. The second lattice pattern 154 may have a density that is greater than a density of the first lattice pattern 152 (such as 10% greater, or such as 50% greater, or such as 100% greater, or such as 200% greater, or such as upwards of 300% greater).

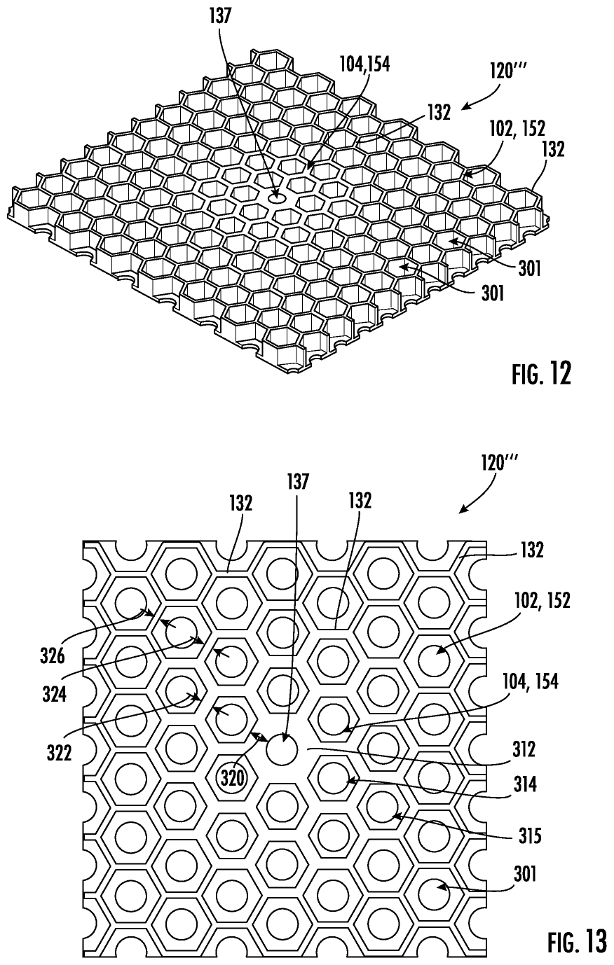

Referring specifically to the embodiment shown in FIGS. 12 and 13, the main body 102 of the core structure”’ may define a first lattice pattern 152 that is the same as a second lattice pattern 154 of the attachment portion 104. More specifically, the geometrical shape of the lattice walls may be understood to be the same. While the geometrical shape of the lattice walls is the same of the wall thickness between the first lattice pattern 152 and the second lattice pattern 154 is not the same. In this manner, the density of the attachment portion 104 may be greater than the density of the main body 102 by varying the thickness of the walls forming the hexagonal units 106. For example, the attachment portion 104 may have a material density (i.e., mass of material per volume) that about 10% greater than the material density of the main body 102 (or such as 50% greater, or such as 100% greater, or such as 200% greater, or such as upwards of 300% greater). This difference in material density can be accomplished by varying the ratio of wall to hollow space within the volume (i.e., thicker walls leads to greater material density, similarly smaller apertures leads to greater material density). An attachment aperture 137 may be defined in the center of the attachment portion 104 (e.g., through a center hexagonal unit 312). Particularly, the attachment portion 104 may include the center hexagonal unit 312, a first group 314 of hexagonal units 301 surrounding the center hexagonal unit 312, and a second group 315 of hexagonal units 301 surrounding the first group 314 of hexagonal units 301. The first group 314 of hexagonal units 301 may be disposed between the center hexagonal unit 312 and the second group 315 of hexagonal units 301.

The hexagonal units 301 may gradually taper in thickness from the attachment aperture 137 to the main body 102. For example, the center hexagonal unit 312 may define a first thickness 320. The lattice walls 132 of each hexagonal unit 301 in the first group 314 of hexagonal units 301 may define a second thickness 322 that is less than the first thickness 320. The lattice walls 132 of each hexagonal unit 301 in the second group of hexagonal units 301 may define a third thickness 324 that is less than the first thickness 320 and the second thickness 322. Lastly, the lattice walls 132 of the hexagonal units 301 in the main body 102 may define a fourth thickness 326 that is less than the first thickness 320, the second thickness 322, and the third thickness 324.

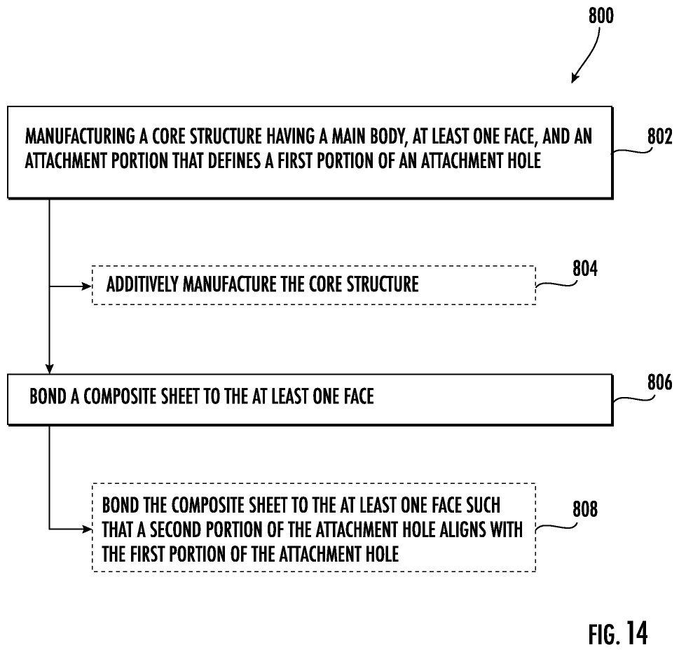

Referring now to FIG. 14, a flowchart diagram of one embodiment of a method 800 of manufacturing a composite panel is illustrated in accordance with embodiments of the present subject matter. In general, the method 800 will be described herein with reference to the composite panels and the core structures described above with reference to FIGS. 1 through 13. However, it will be appreciated by those of ordinary skill in the art that the disclosed method 800 may generally be utilized with any suitable composite panel. In addition, although FIG. 14 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, or adapted in various ways without deviating from the scope of the present disclosure. The dashed boxes may indicate optional steps of the method 800.

As shown in FIG. 14, the method 800 may include at (802) manufacturing a core structure comprising a main body, an attachment portion, and at least one face, the attachment portion defining a first portion of an attachment aperture. As discussed above with reference to FIGS. 1-13, the core structure may include a main body that either includes a plurality of hollow cells (FIGS. 1-4, 6, and 8-13) or that is solid (FIGS. 5 and 7).

In some embodiments, manufacturing at (802) may further include at (804) additively manufacturing the core structure. For example, all or portions of the core structure may be additively manufactured, such as via a binder jet or similar process to produce an additively manufactured core structure. For example, the main body, the attachment portion, and the first portion of the attachment aperture may be additively manufactured. Additively manufacturing the attachment portion and the first portion of the attachment aperture may advantageously prevent the need for post machining of the composite panel or core structure, thereby minimizing machining costs. Particularly, core structure shown in any of the figures may be additively manufactured to produce the plurality of hollow cells. In this way, the plurality of lattice walls may be additively manufactured by building some or all of the plurality of lattice walls in a layer-by-layer manner, such as by using a powder feedstock material.

In such embodiments, additive manufacturing the plurality of lattice walls can result in a residual amount of loose unconsolidated powder feedstock in the hollow interior of each of the plurality of hollow cells. Thus, in some embodiments, the method 800 may further comprise removing the powder feedstock from at least one of the plurality of hollows cells. For example, the powder feedstock may be poured or vacuumed out of an opening of the hollow cell. Removal the powder feedstock can further allow for the unused powder feedstock to be recycled and used to make core structures for additional composite panels or other parts of the composite panel.

While additive manufacturing is disclosed as an exemplary method for manufacturing the core structure, it should be appreciated that other ceramic processing techniques may also be utilized within the scope of this disclosure such as, for example, extrusion processing. Depending on the materials used, the manufacturing process, or other manufacturing variables, the core structure may be ready for use in the composite panel, or may require one or more further intermediate processing steps. For example, in some embodiments, the core structure may be in a green state after additive manufacturing. Thus, in such embodiments, the method may further comprise curing the core structure to remove moister or sintering the core structure.

In exemplary embodiments, the method 800 may further include at (806) bonding a composite sheet to the at least one face, such as a first face of the core structure. In non-limiting examples, the composite face sheet may be bonded to both the main body and the attachment portion of the core structure. Bonding may include any suitable process to mechanically integrate the composite sheet with the core structure. For example, bonding at (806) may include adhesive bonding. In some embodiments, bonding at (806) may include one or more manufacturing steps utilized in manufacturing ceramic matrix composites, such as infiltration of the ceramic material or curing.

In exemplary implementations, bonding at (806) may further include at (808) bonding the composite sheet to the at least one face such that a second portion of the attachment aperture aligns with the first portion of the attachment aperture. For example, the composite sheet may define the second portion of the attachment aperture, which may be aligned with the first portion of the attachment aperture either before or during the bonding of the composite sheet to the core structure.

In some embodiments, the method may further include bonding a second composite sheet to a second side of the core structure such that a third portion of the attachment aperture aligns with the first and second portion of the attachment aperture. For example, the second attachment sheet may bond to another surface of the core structure, and the second attachment sheet may define a third portion of the attachment aperture.

The composite panels as disclosed and described herein may be used in a variety of industrial machines, including but not limited to one or more components of turbomachines. Moreover, the composite panels disclosed and described herein can provide a more cost-effective, lighter, and potentially stronger alternative to solid composite structures. It is to be understood that features of each of the embodiments shown in the figures and discussed above may be combined with features of other embodiments. However, the composite panels disclosed and described herein further provides enhanced bonding between the core structure and the composite sheets. In certain embodiments, the composite panels described herein can allow for differential thermal growth, less layup tooling (since the plies are layered up against the core), the potential to avoid noodles or other filler materials to form radii of curvature, less machining of the final part (lower cost), less coated fiber (lower cost) by only using coated fiber where it is needed, or other advantages.

Further aspects are provided by the subject matter of the following clauses:

A composite panel including a core structure including a main body defining at least one face, wherein an attachment portion is integrally formed with the main body, and the attachment portion defines a first portion of an attachment aperture, a composite sheet bonded to the least one face of the core structure, wherein the composite sheet defines a second portion of the attachment aperture, wherein the first portion of the attachment aperture and the second portion of the attachment aperture align along a common axis.

The composite panel of any of the preceding clauses, wherein the attachment portion forms a local thickened feature.

The composite panel of any of the preceding clauses, wherein the local thickened feature is a flange.

The composite panel of any of the preceding clauses, wherein the attachment portion extends away from the main body to a terminal end, and wherein the attachment aperture is disposed between the main body and the terminal end of the attachment portion.

The composite panel of any of the preceding clauses, wherein the at least one face includes a first face and a second face, wherein the first portion of the attachment aperture extends between the first face and the second face.

The composite panel of any of the preceding clauses, wherein the composite sheet is a first composite sheet bonded to the core structure at the first face, and wherein the composite panel further includes a second composite sheet bonded to the core structure at the second face, wherein the first composite sheet defines the second portion of the attachment aperture, and wherein the second composite sheet defines a third portion of the attachment aperture.

The composite panel of any of the preceding clauses, wherein the core structure further includes a plurality of hollow cells.

The composite panel of any of the preceding clauses, wherein at least one of the plurality of hollow cells includes a hexagonal shape.

The composite panel of any of the preceding clauses, wherein the composite sheet includes a recess, and wherein the second portion of the attachment aperture extends from the recess.

The composite panel of any of the preceding clauses, wherein the attachment aperture defines a non-circular shape.

The composite panel of any of the preceding clauses, wherein the attachment portion includes a material density that is greater than a material density of the main body.

The composite panel of any of the preceding clauses, wherein the main body is defined by a first lattice having a plurality of lattice walls in a first lattice pattern.

The composite panel of any of the preceding clauses, wherein the attachment portion is defined by a second lattice having a plurality of lattice walls in a second lattice pattern that is different than the first lattice pattern.

The composite panel of any of the preceding clauses, wherein the composite sheet includes a ceramic matrix composite.

The composite panel of any of the preceding clauses, wherein the core structure includes a matrix of silicon, silicon carbide, alumina, carbon, aluminosilicates, or combinations thereof.

The composite panel of any of the preceding clauses, wherein the core structure is an unreinforced core structure.

A method of manufacturing the composite panel of any of the preceding clauses, the method including manufacturing the core structure including the main body defining the at least one face and bonding the composite sheet to the at least one face.

The method of any of the preceding clauses, wherein manufacturing the core structure includes additively manufacturing the core structure.

The method of any of the preceding clauses, wherein the core structure includes silicon, silicon carbide, alumina, carbon, aluminosilicates, or combinations thereof.

The method of any of the preceding clauses, wherein the composite sheet includes a ceramic matrix composite.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A composite panel comprising:
a core structure comprising a main body defining at least one face, wherein an attachment portion is integrally formed with the main body, and the attachment portion defines a first portion of an attachment aperture; and
a composite sheet bonded to the least one face of the core structure, wherein the composite sheet defines a second portion of the attachment aperture, wherein the first portion of the attachment aperture and the second portion of the attachment aperture align along a common axis.

2. The composite panel of claim 1, wherein the attachment portion forms a local thickened feature.

3. The composite panel of claim 2, wherein the local thickened feature is a flange.

4. The composite panel of claim 1, wherein the attachment portion extends away from the main body to a terminal end, and wherein the attachment aperture is disposed between the main body and the terminal end of the attachment portion.

5. The composite panel of claim 1, wherein the at least one face includes a first face and a second face, wherein the first portion of the attachment aperture extends between the first face and the second face.

6. The composite panel of claim 5, wherein the composite sheet is a first composite sheet bonded to the core structure at the first face, and wherein the composite panel further comprises a second composite sheet bonded to the core structure at the second face, wherein the first composite sheet defines the second portion of the attachment aperture, and wherein the second composite sheet defines a third portion of the attachment aperture.

7. The composite panel of claim 1, wherein the core structure further comprises a plurality of hollow cells.

8. The composite panel of claim 7, wherein at least one of the plurality of hollow cells comprises a hexagonal shape.

9. The composite panel of claim 1, wherein the composite sheet includes a recess, and wherein the second portion of the attachment aperture extends from the recess.

10. The composite panel of claim 1, wherein the attachment aperture defines a non-circular shape.

11. The composite panel of claim 1, wherein the attachment portion comprises a material density that is greater than a material density of the main body.

12. The composite panel of claim 1, wherein the main body is defined by a first lattice having a plurality of lattice walls in a first lattice pattern.

13. The composite panel of claim 12, wherein the attachment portion is defined by a second lattice having a plurality of lattice walls in a second lattice pattern that is different than the first lattice pattern.

14. The composite panel of claim 1, wherein the composite sheet comprises a ceramic matrix composite.

15. The composite panel of claim 1, wherein the core structure comprises a matrix of silicon, silicon carbide, alumina, carbon, aluminosilicates, or combinations thereof.

16. The composite panel of claim 15, wherein the core structure is an unreinforced core structure.

17. A method of manufacturing the composite panel of claim 1, the method comprising:
manufacturing the core structure comprising the main body defining the at least one face; and
bonding the composite sheet to the at least one face.

18. The method of claim 17, wherein manufacturing the core structure comprises:
additively manufacturing the core structure.

19. The method of claim 18, wherein the core structure comprises silicon, silicon carbide, alumina, carbon, aluminosilicates, or combinations thereof.

20. The method of claim 17, wherein the composite sheet comprises a ceramic matrix composite.
